(19) United States
(12) Patent Application Publication
(10) Pub. No.: US 2009/0126326 A1
(43) Pub. Date: May 21, 2009

(54) Ventilation system air filter and method for manufacturing the same

(76) Inventor: John P. McClellan, Chattanooga, TN (US)

Correspondence Address: KENT MOORE, P.O. BOX 1026, HIXSON, TN, 37343, US

(21) Appl. No.: 11/986,206

(22) Filed: Nov. 20, 2007

(51) Int. Cl. B01D 46/42

(52) U.S. Cl. 55/497

(57) ABSTRACT

An improved air filter for filtering particulate matter from the air flow of a ventilation system and a method for manufacturing the air filter. The air filter comprises an air filter media having a top surface, a bottom surface, and a perimeter. The filter media preferably is a pleated media. A frame surrounds the perimeter of the media. The frame is preferably made of Styrofoam or similar lightweight foaming material. The foam material becomes bonded to the media such that air leakage between the foam material and the media is prevented when the air filter is in use in the ventilation system. Reinforcing ribs may be provided on the media to provide additional structural support for the filter.

### 1. FIELD

The present invention relates generally to the field of air filtration devices for ventilation systems, methods for manufacturing the same, and more particularly to an improved air filtration device having a box frame and a pleated media. The box frame comprises a light weight injection molded foam structure creating the ability to manufacture much more cost-effectively and further creating the ability to manufacture a filter having a very light weight compared to existing filters.

### 2. BACKGROUND

There are three general types of existing air filters for heating, ventilation and air conditioning systems (“HVAC”). One type of filter includes a cardboard frame and a fiberglass media. It is essentially a low efficiency, low cost, throw away filter. The second type of filter includes a replaceable media made of a polyester-type material. It also a low efficiency filter but requires a permanent metal frame. The third type is a box pleat filter comprising a box frame, typically of cardboard, and a medium efficiency pleated filter media. The pleat offers greater surface area of filtration per cross-sectional area of the air return and thus has a higher dust holding capacity and longer life.

The cardboard frame of existing filters is generally time consuming and wasteful to manufacture. For example, the frame must be die-cut from a large piece of cardboard. The cut cardboard forms the frame. However, the remaining cardboard must be discarded resulting in substantial waste. Thus to make a box frame, more cardboard is discarded than is used creating a less than environmentally-friendly manufacturing problem. Also, cardboard, because it is not water resistant, often weakens when too much moisture is present in a filtration system.

Further, unless expensive automation equipment is used, the box frame is vtypically hand made by manually making the folds at the appropriate places, inserting the media and applying glue to secure the frame around and to the media. Because of the manual application of glue, too much glue may be applied causing reduced air flow. Also, too little glue or gaps in the glued areas may cause the air to “bleed” around the filter reducing its efficiency. Further, the manually placed filter may create an uneven spacing in the pleats, thus further reducing the filtering capacity of the media. Finally, many other defects may occur simply because of the manual assembly of the filters.

The present invention represents an improvement in the method of manufacturing air filters and represents and improvement in the air filter itself. The present air filter overcomes the problems associated with existing box pleat filters by utilizing a foam construction for the box frame thus eliminating cardboard, and its associated waste, altogether. Foam is water resistant, can be evenly distributed around the media, will not leak or “bleed” and will fix the pleats of the media in an evenly spaced manner. The method of manufacturing the filter includes automated injection molding of the frame, insuring dimensional accuracy and consistency thus eliminating many of the defects inherent in a manual assembly of the filter.

### 3. SUMMARY

The improved air filter of the present invention for filtering particulate matter from the air flow of a ventilation system comprises an air filter media having a frame formed around the perimeter of the media.

The media can be any type of known filter media having a top surface, a bottom surface, and a perimeter. The media filters particulate matter, such as dust, pollen and other allergens, from the air flowing into a ventilation system by trapping the particulate matter as air flows in the top surface, through the porous filter material, and out from the bottom surface of the filter. A preferred media is a pleated media made from polyester or poly-cotton material. By using a pleat, the surface area of the filter is increased thus increasing the filtering capacity and efficiency of the filter. The pleats may be formed like an accordion having sharp creases at the peaks and valleys of the pleat. In a particularly preferred media, the pleats have a smooth curvature at each peak and valley and are evenly spaced along the length of the media.

The frame preferably is made from a foam material, and most preferably is made from a foamed polypropylene or polyethylene but can also be made from polystyrene (known as Styrofoam® if manufactured by Dupont®). In a preferred embodiment, the frame forms a continuous enclosure around the perimeter of the media, and is bonded to both the top surface and the bottom surface of the media so that air cannot flow or bleed between the frame and the media. In a particularly preferred embodiment, the frame is formed through an injection molding process. Injection molding provides several benefits including but not limited to: Consistent frame size, control over material cost, quality control, reduced manual labor, etc. One or more reinforcing ribs may be integrally formed with the frame using the injection molding process.

The preferred method of manufacturing the filter is generally an injection mold process the steps of which are generally known in the art. It includes the steps of first providing a roll of filter material. The material can be any filter material that is suitable for use in air filters. The preferable filter media is the pleated variety as it provides a greater surface area of filter material and higher efficiency of filtration. The material is pleated and then cut to the appropriate length. The pleated filter material is then fed in to and placed in a lower mold. An upper mold is next lowered onto the lower mold. The molds are shaped such that when they are placed together they form a cavity which is the outline of the shape of the frame. Both upper and lower molds include several injection points to allow the frame material to flow into the cavity so that an even and consistent amount of material is injected. An even distribution of frame foam material insures that the pleated media is sealed around all edges. Once the material has cooled, they upper and lower molds are separated and the finished air filter is removed. The air filter can be stacked with other air filters and shrink wrapped together by any known shrink wrap technique.

In an alternate embodiment, the reinforcing rib may be omitted as components of the upper and lower molds in the injection molding process. Rather the present air filter may include one or more reinforcing ribs as separate pieces made from cardboard, plastic or other suitable material and positioned across the media prior to closing the molds. The rib can be placed either parallel or perpendicular to the direction of the pleat. The ends of the rib are sealed into the frame during the molding process.

Other objects, advantages and capabilities of the present invention will become more apparent as the description proceeds, taken in conjunction with accompanying drawings, in which like parts have similar reference numerals.

### 4. BRIEF DESCRIPTION OF THE DRAWINGS

FIG. 1a shows a perspective view of an improved air filter of the present invention;

FIG. 1b shows a perspective view of the filter media shown in FIG. 1a;

FIG. 1c shows a perspective view of the frame shown in FIG. 1a;

FIG. 2 shows a top view of the improved air filter of the present invention shown in FIG. 1a;

FIG. 3 shows a bottom view of the improved air filter of the present invention shown in FIG. 1a;

FIG. 4 shows a cross-sectional side view of the improved air filter of the present invention shown in FIG. 2;

FIG. 5 shows a preferred process for production of the improved air filter of the present invention;

FIG. 6 shows a perspective view of an alternate embodiment of the filter media of the present invention;

FIG. 7 shows a top view of an alternate embodiment of the filter media of the present invention shown in FIG. 6; and

FIG. 8 shows a bottom view of an alternate embodiment of the filter media of the present invention shown in FIG. 7.

### 5. DETAILED DESCRIPTION

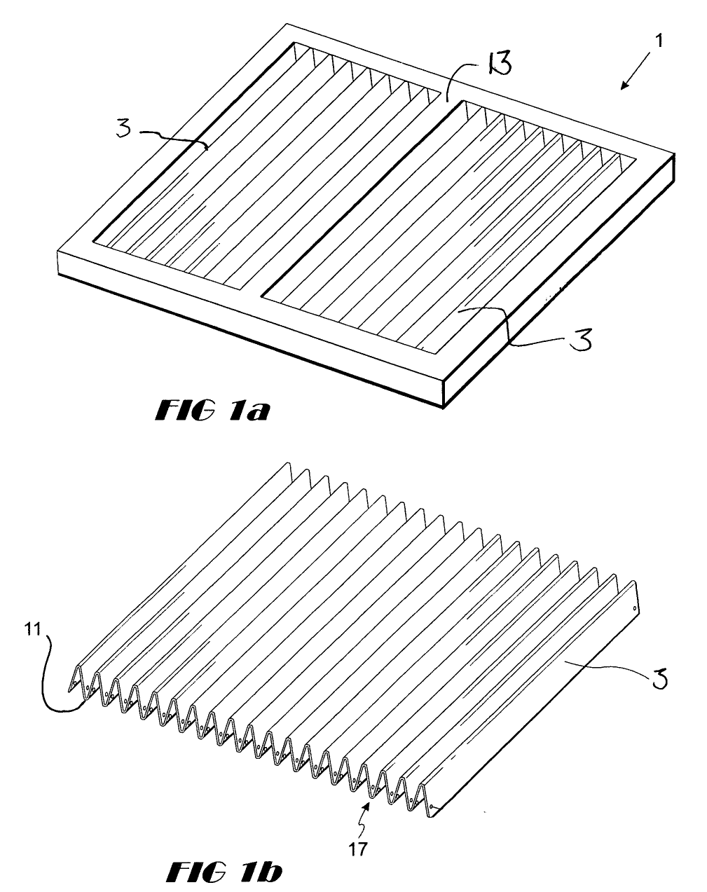

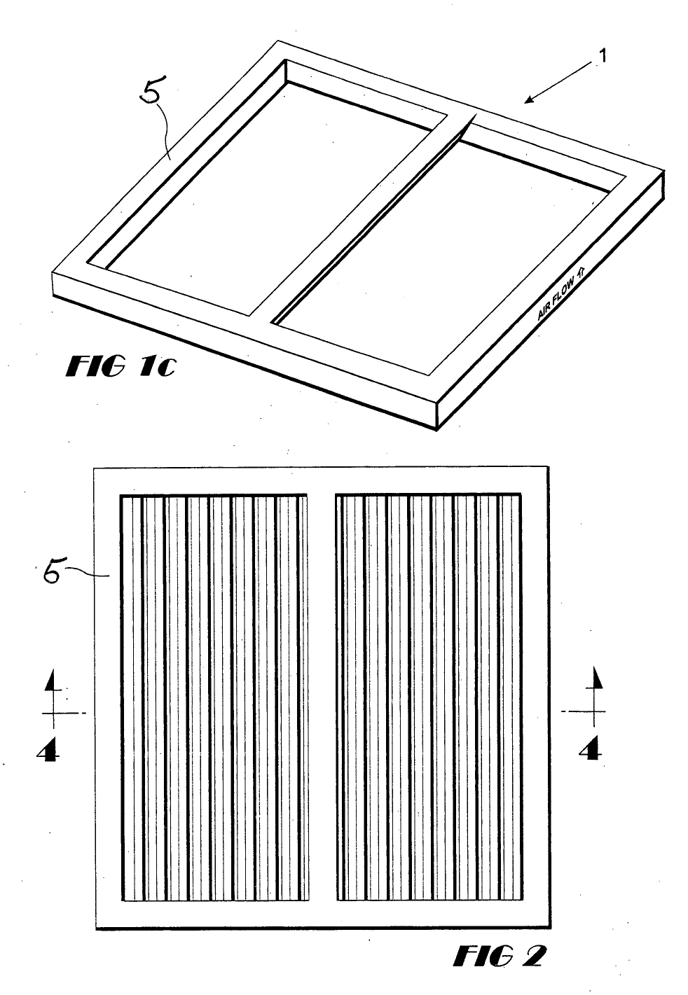

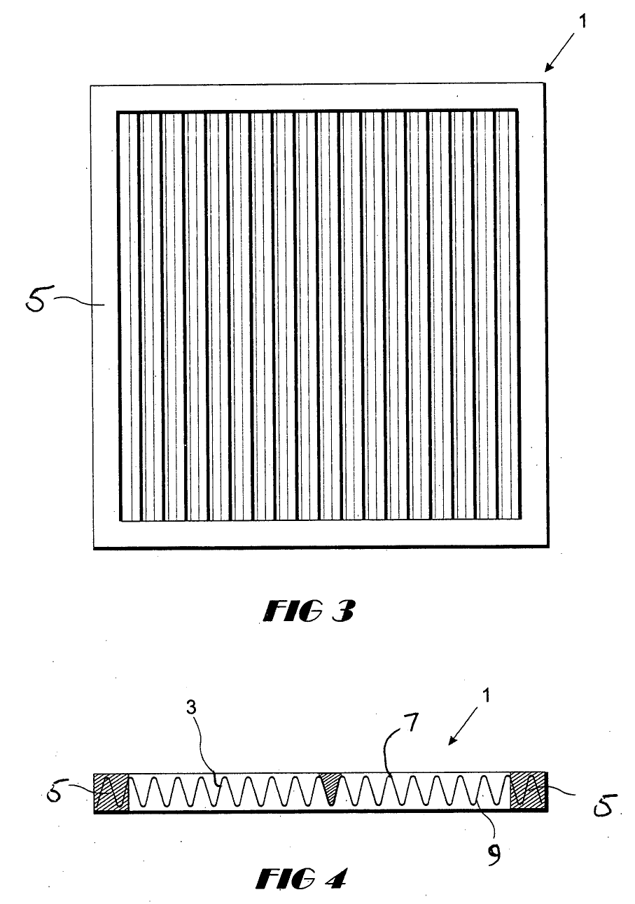

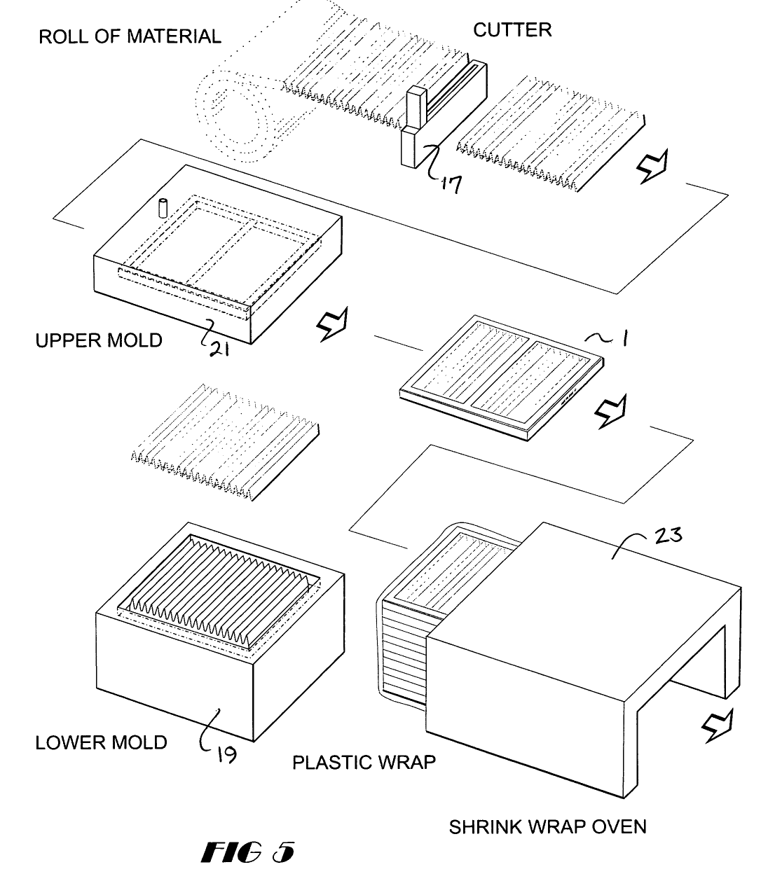

Referring to FIGS. 1-4, the improved air filter 1 of the present invention for filtering particulate matter from the air flow of a ventilation system (not shown) comprises an air filter media 3 having a frame 5 formed around a perimeter 11 of the media 3.

The media 3 can be any type of known filter media having a top surface 7, a bottom surface 9, and perimeter 11. Known filter media include fiberglass, sponge-like media, and pleated media. The pleated media 3 is typically the most efficient media available. By choosing an efficient filtering media, the air being distributed to the ventilation areas is cleaner and the internal components of the air ventilation system stay cleaner thereby increasing the life of the system. The media 3 filters particulate matter such as dust, pollen and other allergens and material, from the air flowing into a ventilation system by trapping the particulate matter as air flows in the top surface 7, through the porous filter media 3, and out from the bottom surface 9 of the media 3.

A preferred media 3 is a pleated media. By using a pleat 17, the surface area of the filter 1 can be increased thus increasing the filtering capacity and efficiency of the filter 1. The pleats 17 may be formed like an accordion having sharp creases at the peaks and valleys of the pleat 17. However, it is difficult to maintain even spacing between the pleats 17 with an accordion-style pleat. Therefore, in a particularly preferred media 3, the pleats 17 have a smooth curvature at each peak and valley and are evenly spaced along the length of the media 3.

The frame 5 preferably is made from a foam material such as polyurethane, plastisol or silicone. The frame 5 most preferably is made from a Styrofoam material. In a preferred embodiment, the frame 5 forms a continuous enclosure around the perimeter 11 of the media 3, and is securely bonded to both the top surface 7 and the bottom surface 9 of the media 3 so that air cannot flow or bleed between the frame 5 and the media 3. Any air that bleeds around the media 3 also will carry particulate matter and thus reduce the efficiency of the filter 1. The present air filter 1 may include one or more reinforcing ribs 13 formed integrally with the frame 5 to provide stability to the air filter 1.

The preferred method of manufacturing the filter is generally an injection mold process the steps of which are generally known in the art. Injection molding provides several benefits including but not limited to: consistent frame size, control over material cost, quality control, reduced manual labor, and ease of preparation for shipment.

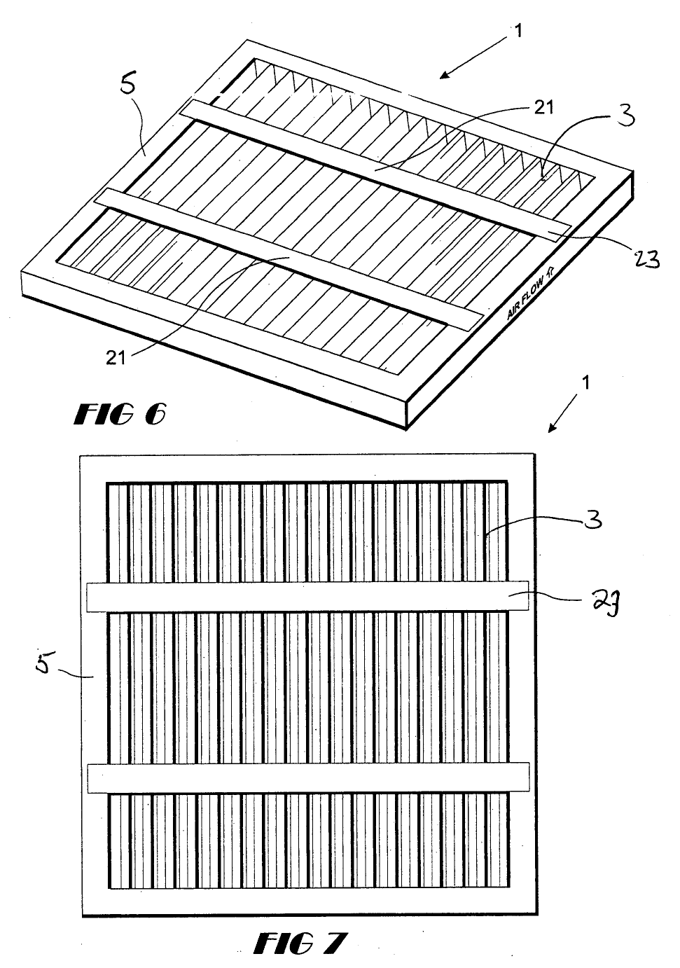

Referring to FIG. 5, the process flow is generally shown with arrows. The process includes the steps of first providing a roll of filter material 15. The material 15 can be any filter material 15 that is suitable for use in air filters. The preferable filter material 15 is the pleated variety as it provides a greater surface area of filter material 15 and higher efficiency of filtration. The material 15 is pleated and then cut to the appropriate length in a cutter 17. The pleated filter material 15 is then fed in to and placed in a lower mold 19. An upper mold 21 is next lowered onto the lower mold 19. The molds 19, 21 are shaped such that when they are placed together they form a cavity which is the outline of the shape of the frame 5. Both upper and lower molds include several injection points to allow frame material in a liquid state to be injected into the cavity so that an even and consistent amount of material is injected. An even distribution of frame material insures that the pleated media 15 is sealed around all edges. Once the material has cooled and solidified, they upper and lower molds 19, 21 are separated and the finished air filter 1 is removed. The air filter can be stacked with other air filters and shrink wrapped together by any known shrink wrap technique 23.

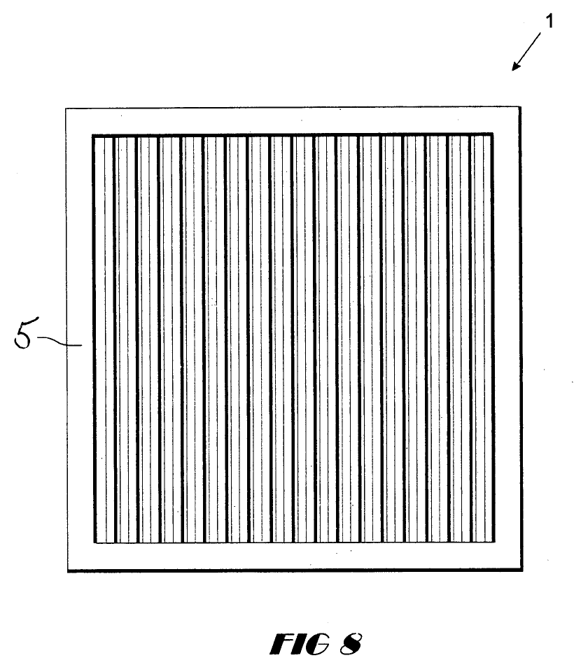

In an alternate embodiment, the reinforcing rib may be omitted as components of the upper and lower molds in the injection molding process. Rather, referring to FIGS. 6-8, the present air filter 1 may include one or more reinforcing ribs 21 made from cardboard or other suitable material and positioned across the media 3 prior to closing the molds. The rib 21 can be placed either parallel or perpendicular to the direction of the pleat. The ends of the rib 23 are sealed into the frame 5 during the molding process.

It should be appreciated that the illustrated and described embodiments are examples and not limitations on the present invention. The variations and other embodiments are defined by the scope of the following claims.

1. An improved air filter for filtering particulate matter from the air flow of a ventilation system, said air filter comprising:
a. an air filter media having a top surface, a bottom surface, and a perimeter;
b. a frame around the perimeter of the media;
c. said frame comprising a foamed material; and
d. said foam material being bonded to the media.

2. The improved air filter of claim 1 wherein the media is a pleated air filter media comprising at least two pleats.

3. The improved air filter of claim 1 wherein the frame of foamed material is injection molded.

4. The improved air filter of claim 1 wherein the foam material is bonded to both the top surface and the bottom surface of the media.

5. The improved air filter of claim 1 wherein the air filter comprises at least one supporting rib extending across the filter material and joined on each end to the frame.

6. The improved air filter of claim 1 wherein the foamed material is selected from a group consisting of styrofoam, polyurethane, plastisol and silicone.

7. The improved air filter of claim 5 wherein the air filter comprises two supporting ribs.
